(19) United States
(12) Patent Application Publication
(10) Pub. No.: US 2016/0070861 A1
(43) Pub. Date: Mar. 10, 2016

(54) GENERATING AND/OR EMPLOYING FINDING UNIQUE IDENTIFIERS

(71) Applicant: KONINKLIJKE PHILIPS N.V., Eindhoven (NL)

(72) Inventors: Shyam Bharat, Cortlandt Manor, NY (US); Lilla Boroczky, Mount Kisco, NY (US)

(73) Assignee: Koninklijke Philips N.V., Eindhoven (NL)

(21) Appl. No.: 14/768,503

(22) PCT Filed: Mar. 17, 2014
(86) PCT No.: PCT/IB2014/059889

§ 371 Date: Aug. 18, 2015

Related U.S. Application Data
(60) Provisional application No. 61/806,496, filed on Mar. 29, 2013.

(51) Int. Cl. G06F 19/00

(52) U.S. Cl. CPC G06F 19/322

(57) ABSTRACT

Described herein are a system(s) and/or a method(s) that associate results of medical procedures for a particular medical finding over a lifetime of the finding. A method includes tagging, with a same finding unique identifier tag (FUID), electronic formatted medical results from different events for a same finding of a patient, storing the electronic formatted medical results along with the FUID, wherein the stored tagged different electronic formatted medical results provide a longitudinal record for the finding from discovery of the finding through a last event for the finding. A system includes a FUID repository that stores a single FUID for each different finding for each different patient, and a new FUID generator that generates a new FUID for a new finding. The FUIDs in the FUID repository are accessible to a plurality of medical facilities which tag electronic data for a same finding with a same FUID.

The following generally relates to generating and/or utilizing finding unique identifiers for medical finding.

Information about a medical finding over a lifetime of the finding, for example, from discovery of the finding thereof through a last event for the finding, can be generated by various different sources such as an emergency department, a primary care physician, an oncologist, a treatment center, etc. While the individual sources may have their own quality assurance and quality control in place, inter-source communication of such data, unfortunately, is not well developed. As such, a source may not have access to information from another source about a same finding.

By way of non-limiting example, with respect to the domain of medical oncology, the patient often visits various departments (and possibly, different institutions) in the period from initial diagnosis to therapy and post-therapy follow up. With lack of inter-departmental (and inter-institutional) communication, consequently, there is usually no short and/or long-term, outcome-based quality assurance and/or quality control on a patient-specific and finding-specific basis. As a result, there is little or no information recorded that can derive potential correlations between a certain treatment protocol for a particular tumor and corresponding short and/or long-term outcomes.

Aspects described herein address the above-referenced problems and others.

In one aspect, a method includes tagging, with a same finding unique identifier (FUID), electronic formatted medical results from different events for a same finding of a patient. The method further includes storing the electronic formatted medical results along with the finding unique identifier tag. The stored tagged different electronic formatted medical results provide a longitudinal record for the finding from discovery of the finding through a last event for the finding.

In another aspect, a system includes a finding unique identifier (FUID) repository that stores a single FUID for each different finding for each different patient; and a new FUID generator that generates a new FUID for a new finding and stores the new FUID in the FUID repository. The FUIDs in the FUID repository are accessible to a plurality of medical facilities which tag electronic data for a same finding with a same FUID.

In another aspect, a computer readable storage medium is encoded with one or more computer executable instructions, which, when executed by a processor of a computing system, causes the processor to: tag, with a same finding unique identifier (FUID), electronic formatted medical results from different events for a same finding of a patient, thereby creating a longitudinal record for the finding from discovery of the finding through a last event for the finding.

The invention may take form in various components and arrangements of components, and in various steps and arrangements of steps. The drawings are only for purposes of illustrating the preferred embodiments and are not to be construed as limiting the invention.

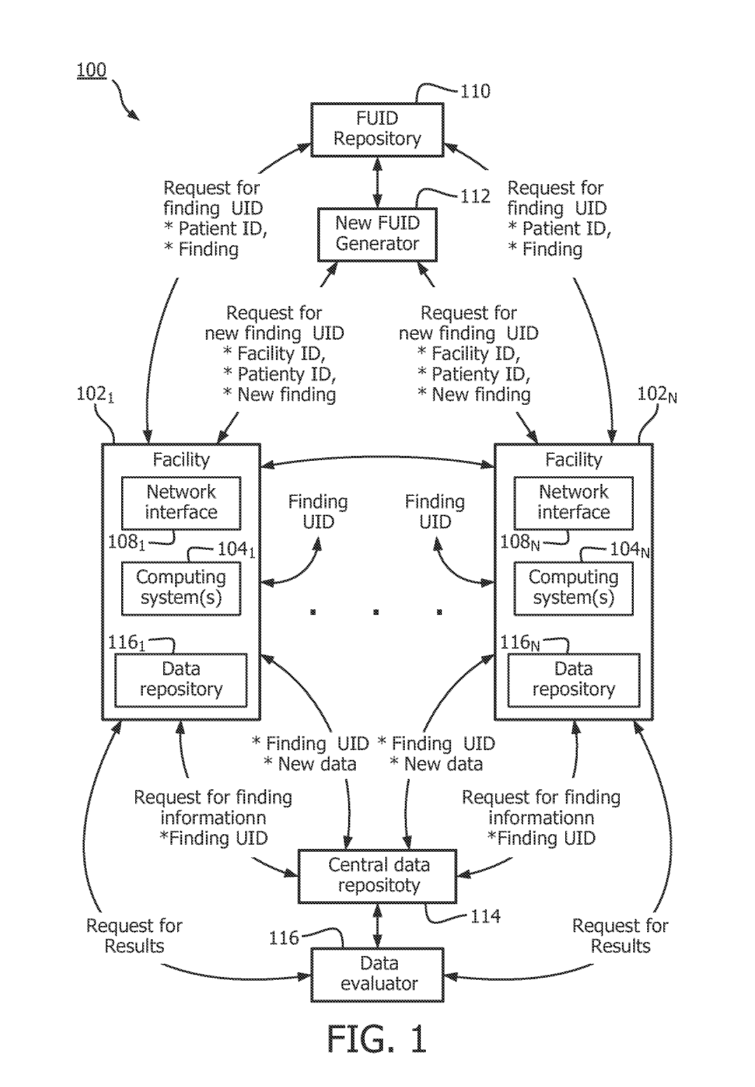

FIG. 1 schematically illustrates an example system in which events for a particular finding for a patient are tagged with a same finding unique identifier.

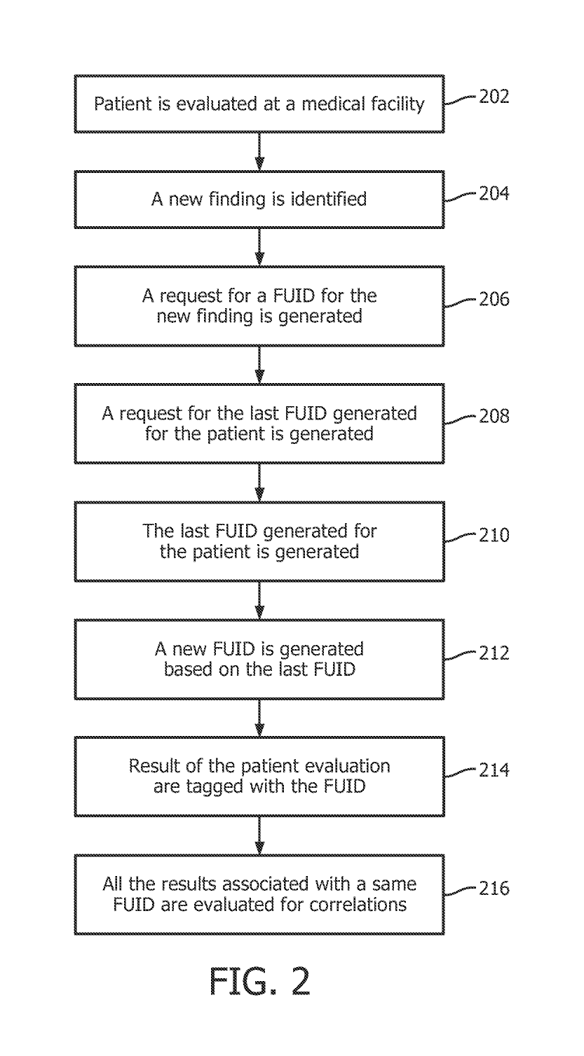

FIG. 2 illustrates an example method for generating a new finding unique identifier for a newly discovered finding.

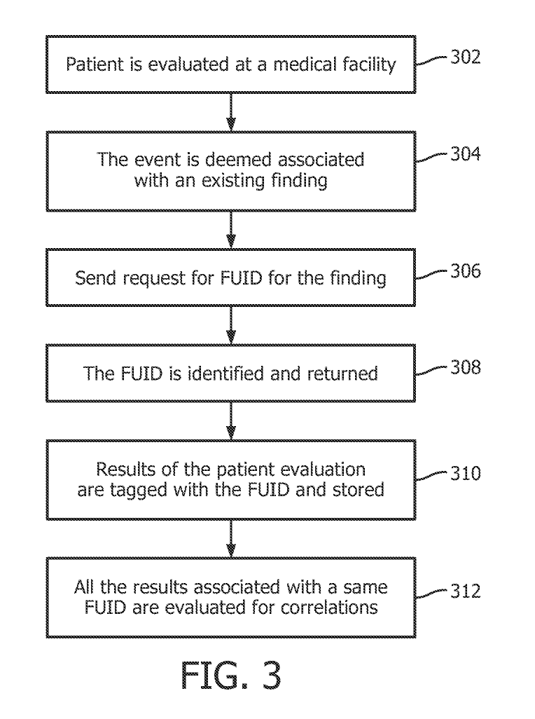

FIG. 3 illustrates an example method for tagging an event for a finding with an existing finding unique identifier for the finding.

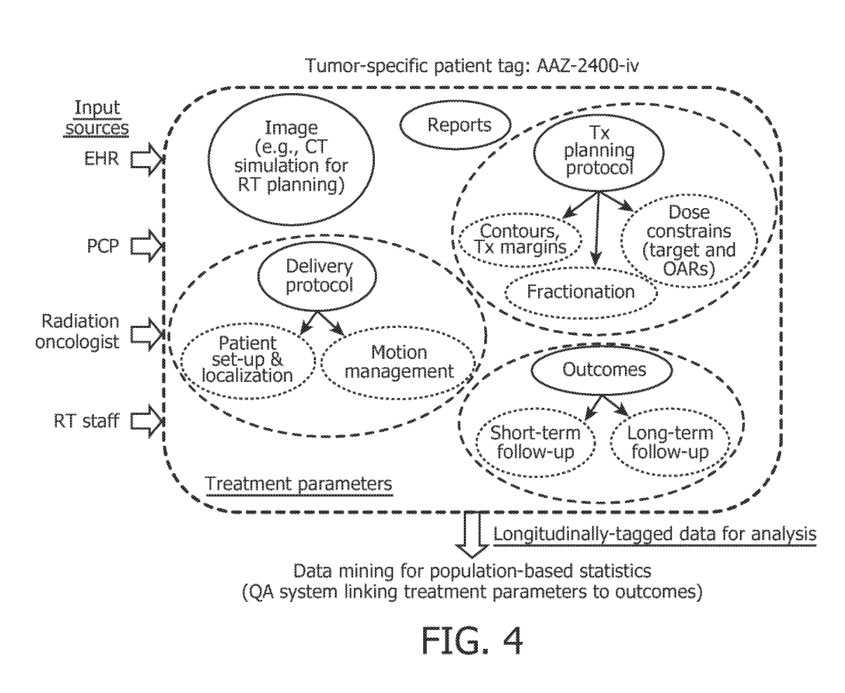

FIG. 4 illustrates a longitudinally-tagged tumor-specific radiation therapy example in accordance with FIGS. 1, 2 and 3.

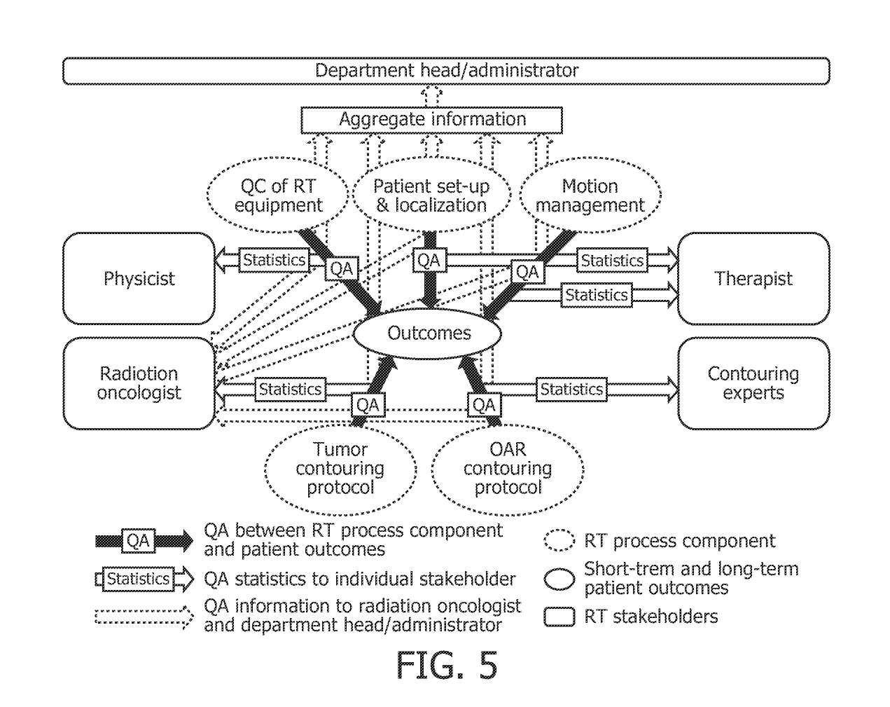

FIG. 5 illustrates a longitudinally-tagged tumor-specific radiation therapy example for generating data for individual RT stakeholders in accordance with FIGS. 1, 2 and 3.

The following generally relates to associating results of medical procedures, only for a particular medical finding, over a lifetime of the finding, for example, from discovery of the finding through a last procedure performed for the finding, with a same finding unique identifier. Examples of a finding include, but are not limited to, a tumor, pneumonia, anemia, disease, and/or other medical condition and/or state of the patient.

Initially referring to FIG. 1, a system 100 includes N medical facilities 102₁, . . . , 102_{N} (collectively referred to as medical facilities 102 herein), where N is an integer. As used herein, a medical facility includes one or more of a hospital, a network of hospitals, a clinic, an emergency center, a physician's office, an imaging center, a laboratory, a therapy center, a treatment center, and the like.

The medical facilities 102 respectively include sets of computing systems 104₁, . . . , 104_{N} (collectively referred to as computing systems 104 herein). A particular set of computing systems 104 for a particular medical facility 102 may be distributed throughout the facility in one or more departments. One or more of the computing systems 104 can be networked together via an inter- and/or an intra-department local area network (LAN). Generally, a computer system will include a general purpose computer with a micro-processor and physical memory and/or other computer.

The medical facilities 102 also respectively include sets of data repositories 106₁, . . . , 106_{N} (collectively referred to as data repositories 106 herein). A particular set of data repositories 106 for a particular medical facility 102 may be distributed throughout the facility in one or more departments and can also networked together via the local area network (LAN). The data repositories 106 store electronic data, such as imaging data, laboratory results, etc. generated in electronic format.

The medical facilities 102 also respectively include sets of network interfaces 108₁, . . . , 108_{N} (collectively referred to as network interfaces 108 herein), which allow the medical facilities 102 to communicate with each other and/or other networks and/or devices, for example, via a wide area network (WAN).

The system 100 also includes a finding unique identifier (FUID) repository 110. The FUID repository 110 stores FUID's, or unique identifiers for finding. Each finding is assigned its own FUID, and the FUID's for the different findings are stored in the FUID repository 110. The FUID repository 110 can be centralized (as shown) or distributed across sub-repositories.

In one non-limiting instance, a FUID includes at least three portions concatenated together. By way of non-limiting example, a first portion may identify the facility at which the finding was discovered, a second portion may identify the patient, and a third portion may identify the finding chronologically, for example, the number “10,” letter “j,” etc. may identify the finding as the tenth discovered finding for the patient.

The three portions may be variously connected together and need not be first portion, followed by second, followed by third. An example of a FUID is: “AAA-2400-iv,” where “AAA” refers to the facility at which the finding was discovered, “2400” refers to the patient, and “iv” refers to the fourth finding. Other examples include, but are not limited to, “AAA2400iv,” “2400-AAA-iv,” “AAA-2400-0004,” “2400-iv-AAA,” and/or other FUID, including a FUID with more or less portions and/or different descriptors.

A facility 102 can request a FUID for a finding from the FUID repository 110. This may include querying the FUID repository 110 based on a patient identification (ID) (for example, but not limited to, patient name) and information describing a particular finding. In one instance, a facility 102 requests a FUID when a clinician deems a complaint, visit, event, etc. of the patient as corresponding to an existing finding. Electronic information corresponding to the complaint, visit, event, etc. is tagged with the FUID. If the facility 102 already has the FUID, for example, for a previous event with the patient, the facility 102 need not request the FUID.

If the clinician deems that the current case is a new finding and is not related to an existing FUID, the process of generating a new FUID is initiated. A new FUID generator 112 generates a FUID for a newly discovered finding. This includes identifying the finding portion of the previously generated FUID for the patient so that a next finding portion can be determined. For instance, where, for the last FUID generated, the finding portion is the number “10,” letter “j,” etc., the new finding portion would be the number “11,” letter “k,” etc.

Thus, two FUIDs for two different findings for a same patient and from a same facility will include a same identification of the facility and a same identification of the patient, but different unique alphanumeric characters for the findings. If the facilities are different, the identification of the facility will also be different. The finding portion can be determined by querying the FUID repository 110 for the last FUID generated for the patient.

The new FUID generator 112 generates the FUID for the new finding using, for example, the three above discussed portions, namely, the identity of the facility at which the finding was discovered, the identity of the patient, and the new finding portion. Upon generating a new FUID, the FUID is provided at least to the facility requesting the FUID and the FUID repository 110.

A central data repository 114 stores electronic data from each of the facilities 102. In the illustrated example, this includes storing imaging data, laboratory test results, etc. along with the corresponding FUID's such that all the results for a particular finding are associated with a same FUID for that finding. The data can be stored based on FUID, patient identity and/or otherwise, and be sortable and/or searchable based on FUID, patient identity and/or otherwise. As shown, a facility 102 can request and/or receive data from the central data repository 114.

A data evaluator 116 evaluates the data stored in the central data repository 114. Such evaluation may include, but is not limited to, evaluating particular procedures ordered and/or performed for a particular finding, the outcome thereof, etc. Such data, for a plurality of patients, can be utilized to generate protocols and/or provide to clinicians ordering procedures for patients. As shown, a facility 102 can request and/or receive data from the data evaluator 116.

In one non-limiting instance, the data evaluator 116 generates statistics that can derive potential correlations between a certain protocol for a particular finding (e.g., with respect to a tumor, based on a tumor location, cancer type and subtype, etc.) and corresponding long-term outcomes, not only with respect to patient survival but also quality of life, side effects, development of metastases etc.

The new FUID generator 112 and/or the data evaluator 116 can be implemented via one or more processors of one or more computers executing one or more computer executable instructions stored on one or more computer readable storage mediums such as physical memory and/or other non-transitory medium. At least one instruction can additionally or alternatively be stored on transitory medium such as a carrier wave, a signal and/or the non-physical medium. The data repositories 106, the FUID repository 110 and/or the central data repository 114 can include data bases and/or other physical memory.

It is to be appreciated that the system 100 provides long-term, outcome-based quality assurance (QA) and/or quality control (QC) on a patient-specific and/or finding-specific basis and that this information can be used to derive potential correlations between a certain protocol for a particular finding and corresponding long-term outcomes.

This longitudinal outcome can link a patient's progress from initial discovery of a finding through treatment and subsequent follow-up, with information from each event associated with the finding being tagged with the same FUID. This may serve as an overall QA system that can also be used as an educational tool for improving outcomes, improving medical procedures, protocols, workflow, and patients' quality of life.

FIG. 2 illustrates a method for generating a FUID for a newly discovered finding.

It is to be appreciated that the ordering of the acts in the methods is not limiting. As such, other orderings are contemplated herein. In addition, one or more acts may be omitted and/or one or more additional acts may be included.

At 202, a patient is evaluated at a medical facility, for example, by a clinician. This may be in response to a scheduled general checkup, a particular complaint and/or symptom, a screening examination, etc.

At 204, the clinician identifies a new finding for the patient based on a result of the evaluation.

At 206, a computing system 104 is utilized to send an electronic request to the new FUID generator 112 for a FUID for the finding.

At 208, the new FUID generator 112 queries the FUID repository 110 for the last FUID generated for the patient.

At 210, the FUID repository 110 returns the last FUID, if a FUID exists, for the patient or an indication that no FUID exists.

At 212, the new FUID generator 112 generates a FUID for the finding. As described herein, in one instance, the FUID includes an identification of the facility, an identification of the patient, and a unique alphanumeric character for the finding, which is generally sequential with respect to the last unique alphanumeric character for the most recent previous finding.

At 214, results of the evaluation are stored in electronic format, along with the FUID, in the data repository 106 and/or central data repository 114.

At 216, optionally, results stored on the central data repository 114 are evaluated. As described herein, this may include deriving potential correlations between a certain protocol for a particular finding and corresponding outcomes.

The above methods may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

FIG. 3 illustrates a method for tagging electronic formatted results for a finding with a FUID for the finding.

It is to be appreciated that the ordering of the acts in the methods is not limiting. As such, other orderings are contemplated herein. In addition, one or more acts may be omitted and/or one or more additional acts may be included.

At 302, a patient is evaluated at a medical facility, for example, by a clinician. This may be in response to a scheduled general checkup, a particular complaint and/or symptom, a screening examination, etc.

At 304, the clinician deems the event associated with an existing finding.

At 306, a computing system 104 is utilized to send an electronic request to the FUID repository for the FUID of the finding.

At 308, the FUID repository 110 returns the FUID. As described herein, in one instance, the FUID includes an identification of the facility at which the finding was discovered, an identification of the patient, and a unique alphanumeric character for the finding, which is generally sequential with respect to the last unique alphanumeric character for the most recent previous finding.

At 310, results of the evaluation are stored in electronic format, along with the FUID, in the data repository 106 and/or central data repository 114.

At 312, optionally, results stored on the central data repository 114 are evaluated. As described herein, this may include deriving potential correlations between a certain protocol for a particular finding and corresponding outcomes.

Although the examples herein as discussed in relation to tagging electronic formatted data, it is to be understood that that the tagged data does not have to be in electronic format. For example, a tag can be applied to a paper report or other physical report, which is subsequently converted into electronic format. However, such a report does not have to be converted.

The above methods may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

The following describes an example in connection with an oncology case scenario. However, it is to be understood that this example is non-limiting and provided for explanatory purpose, and other scenarios are also contemplated herein.

Examples of data that can be stored in electronic format along with a FUID include, information corresponding to radiation therapy, chemotherapy, surgical resection, other information, statistics, etc.

With respect to radiation therapy, such data includes one or more of the following and/or other information: a treatment planning protocol (e.g., simulation, margins, dose to target, dose to organs at risk (OAR), fractionation scheme etc.), a delivery protocol (e.g., patient set-up and localization, motion management etc.), daily and/or monthly quality assurance (QA) protocol of RT delivery apparatus (e.g., linear accelerator (linac)), patient characteristics such as age at diagnosis, ethnicity, prior tumor findings and related treatment, etc., and/or other information.

With respect to chemotherapy, such data includes one or more of the following and/or other information: specific markers detected during histopathological analysis of biopsy samples, therapy details (drug utilized, medication level, duration etc.), patient characteristics such as age at diagnosis, ethnicity, prior tumor findings and related treatment, etc., and/or other information.

With respect to surgical resection, such data includes one or more of the following and/or other information: surgical margins used, complications encountered (if any) during surgical procedure, patient characteristics such as age at diagnosis, ethnicity, prior tumor findings and related treatment, etc., and/or other information.

Other information may include, but is not limited to, information about metastases and/or treatment initiation. Suitable metastases information may indicate whether the present tumor that is being treated metastased from a previous tumor, and, if so, should it be tagged with the FUID of the primary tumor or should it have its own FUID. The oncologist makes this decision. Suitable treatment initiation information may indicate whether a treatment procedure (e.g., chemotherapy) follows multiple tumor findings, and if so, which particular tumor finding initiated the course of chemotherapy.

Suitable statistics include statistics derived from mining data for other findings. For example, population-studies may conclude that, in a certain institution, the RT treatments of the left breast resulted in ‘better’ outcomes than RT treatments of the right breast. This can prompt a review of the treatment planning protocols used for treatment of the right breast.

Suitable statistics may also include other metrics derived for specific stakeholders. For RT, the QA metrics often utilized by an oncologist, dosimetrist, therapist, physicist and patient are different. This data will be mined accordingly to provide value-added to all stakeholders in the RT process.

FIG. 4 illustrates different stages in an example RT treatment of a tumor. However, it is to be understood that non-tumor and/or non-RT treatment applications are also contemplated herein.

Information from different sources (e.g., the electronic health record (EHR) of the patient, the primary care practitioner (PCP) or medical expert who referred the patient for RT, the radiation oncologist and other RT staff, namely, the physicists, dosimetrists, therapists etc.) are incorporated into the reporting paradigm. The treatment parameters relevant to RT are recorded from all stages of the RT procedure, starting with the patient's diagnostic reports of the tumor being treated, CT simulation for treatment planning, planning and delivery protocols and outcomes (short- and long-term).

This information is assigned a FUID tag that is specific to the tumor being treated. As described herein, the FUID can have multiple parts, including the facility ID of the facility at which the tumor was discovered, the patient ID, and the tumor identifier. If the same patient later undergoes treatment for another tumor that is deemed to not be related to this tumor, then that treatment is assigned a FUID with a different tumor identifier. Generally, any alphanumerical characters can be used represent the tumor identifier, but it needs to be unique for each different tumor.

The FUID is then used by all facilities that serve the patient for any diagnosis/treatment that is deemed to be related to the tumor finding. Thus, any report originating from these patient visits will be tagged with the same FUID, leading to longitudinal continuity in reporting.

The data evaluator 116 can process this temporally-linked information and derive potential correlations between treatment protocols, treatment parameters, specific types of tumors, location of tumors, etc. and long-term patient outcomes, such as: derive correlations between treatment parameters and treatment outcomes (currently hidden due to lack of recorded data), isolate outcomes and link to specific tumor types or finding, derive specialized metrics for individualized stakeholders, etc.

The latter is illustrated in FIG. 5 in connection with RT. In this example, the therapist is interested in knowing how the delivery protocol that he/she uses affects the long-term outcomes in patients. As another example, the segmentation experts in RT are interested in knowing the link (if any) between normal tissue contouring protocols and long term survival outcomes and normal tissue toxicities. As another example, the physicists in RT can compare the appropriateness of different equipment QC protocols by comparing the long term outcomes of patients who underwent treatments with those protocols

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method, comprising:
tagging, with a same finding unique identifier FUID, electronic formatted medical results from different events for a same finding of a patient;
storing the electronic formatted medical results along with the finding unique identifier tag,
wherein the stored tagged different electronic formatted medical results provide a longitudinal record for the finding from discovery of the finding through a last event for the finding, and
wherein the FUID includes an identification of a facility at which the finding was discovered, an identification of the patient, and a unique alphanumeric character for the finding.

2. (canceled)

3. The method of claim 1, wherein two FUIDs for two different findings for a same patient and from a same facility will include a same identification of the facility and a same identification of the patient, but different unique alphanumeric characters for the findings.

4. The method of claim 1, further comprising:
generating the FUID for the finding in response to the finding being a newly discovered finding, prior to tagging and storing.

5. The method of claim 4, further comprising:
identifying a last previous FUID for the patient; and
generating the FUID based on the last previous FUID, wherein the FUID and the last previous FUID are different.

6. The method of claim 1, further comprising:
identifying the FUID for the finding in response to an event corresponding to an existing finding, prior to tagging and storing.

7. The method of claim 6, further comprising:
tagging the finding with the identified FUID.

8. The method of claim 1, wherein the tagged different electronic formatted medical results are stored in a central data repository accessible to a plurality of different medical facilities.

9. The method of claim 1, further comprising:
processing stored results to derive correlations between a certain protocol for a particular finding of the patient indicated by a particular FUID and corresponding long-term outcomes for the particular findings with other patients.

10. The method of claim 9, wherein the correlations correspond to one or more of patient survival, a quality of life, a side effects, or a development of metastases.

11. A system, comprising:
a finding unique identifier FUID repository configured to store a single FUID for each different finding for each different patient; and
new FUID generator configured to generate a new FUID for a new finding and store the new FUID in the FUID repository,
wherein FUIDs in the FUID repository are accessible to a plurality of medical facilities which tag electronic data for a same finding with a same FUID;
wherein the stored tagged different electronic formatted medical results provide a longitudinal record for the finding from discovery of the finding through a last event for the finding; and
wherein a FUID includes an identification of a facility at which the finding was discovered, an identification of the patient, and a unique alphanumeric character for the finding.

12. (canceled)

13. (canceled)

14. The system of claim 11, wherein the new FUID generator is configured to generate a new FUID for a finding in response to the finding being a newly discovered finding.

15. The system of claim 14, wherein the new FUID generator is configured to identify a last previous FUID for the patient and generates the FUID based on the last previous FUID, wherein the FUID and the last previous FUID are different.

16. The system of claim 11, wherein the new FUID generator is configured to identify the FUID for the finding in response to an event corresponding to an existing finding.

17. (canceled)

18. The system of claim 11, further comprising:
a data evaluator configured to process stored results to derive correlations between a certain protocol for a particular finding of the patient indicated by a particular FUID and corresponding long-term outcomes for the particular findings with other patients.

19. (canceled)

20. A computer readable storage medium encoded with one or more computer executable instructions, which, when executed by a processor of a computing system, causes the processor to:
tag, with a same finding unique identifier FUID, electronic formatted medical results from different events for a same finding of a patient,
store the electronic medical results along with the finding unique identifier tag, and thereby create a longitudinal record for the finding from discovery of the finding through a last event for the finding;
wherein the FUID includes an identification of a facility at which the finding was discovered, an identification of the patient, and a unique alphanumeric character for the finding.
